(19) United States
(12) Patent Application Publication
(10) Pub. No.: US 2014/0015349 A1
(43) Pub. Date: Jan. 16, 2014

(54) INTERLOCKING COIL ISOLATORS FOR RESIN RETENTION IN A SEGMENTED STATOR ASSEMBLY

(71) Applicant: Remy Technologies, LLC, Pendleton, IN (US)

(72) Inventors: Bradley D. Chamberlin, Pendleton, IN (US); Cary Ramey, Greenwood, IN (US)

(21) Appl. No.: 13/939,040

(22) Filed: Jul. 10, 2013

Related U.S. Application Data
(60) Provisional application No. 61/670,473, filed on Jul. 11, 2012.

(51) Int. Cl. H02K 3/34; H02K 15/10; H02K 3/38

(52) U.S. Cl. CPC H02K 3/345; H02K 3/38; H02K 15/10
USPC 310/43; 29/596; 310/71; 310/214; 310/215

(57) ABSTRACT

A stator assembly of an electric machine includes a segmented lamination stack formed of an interconnected series of lamination segment stacks, and a plurality of coil isolators each having a conductor wound thereon, each having a radially outward interlock at each circumferential end thereof, and each having a radially inward interlock at each circumferential end thereof, the coil isolators being serially connected by the interlocks to form a cavity closed down the axial length of the stator assembly, the coil isolators electrically insulating the lamination segments from the conductors.

### RELATED APPLICATIONS

This application claims the benefit of U.S. patent application Ser. No. 61/670,473 filed Jul. 11, 2012, which is incorporated herein by reference in its entirety.

### BACKGROUND

The present invention relates to electric machines and, more particularly, to electric machines having a segmented stator.

There is an increasing demand for greater efficiency and improved power and torque densities in electric machines. Conventional electric machines often have a stator core formed out of stacked laminations with inwardly projecting teeth defining slots between the teeth. In many electric machines, e.g., brushless AC and DC electric machines, coils are wrapped about individual teeth and the copper wire forming the coils fills the slots. When the stator core is a single structure forming a complete ring, access to the slots presents manufacturing difficulties which limit the density of the copper wire achievable within each of the slots. The density of the wires within the slots has a direct impact on the efficiency and power and torque densities of the resulting electric machine, where higher fill factors provide enhanced performance characteristics.

One known method of increasing the slot fill factor of an electric machine is to use a segmented stator core. Instead of winding coils around the teeth of a unitary one piece stator core, segmented stator cores are manufactured by first forming individual stator teeth out of a stack of laminations. Wire coils are then wound about individual stator teeth. After the coils are completed, the individual teeth with coils thereon are assembled into a ring and joined together to form the stator assembly. The ability to wind coils around individual stator teeth without any adjacent teeth inhibiting access during the winding process allows segmented stator cores to realize a higher slot fill density and the enhanced performance characteristics provided thereby.

Coil isolators are commonly used in segmented stator assemblies. Coil isolators may be overmolded onto the lamination stack or may be formed as a two-piece structure that is assembled over the top of the lamination stack. For example, coil isolators may be formed of thermally conductive, electrically insulating resin that prevents contact between the coil conductor and the lamination steel.

Generally, maximizing the transfer of heat out of an electric machine is critical for obtaining continuous performance that meets or exceeds reliability criteria. One method for improving heat transfer from the electric machine includes placing a thermally conductive material such as potting compound around the coil windings of a stator. However, a segmented stator assembly is not properly structured for installing and retaining thermally conductive material. As a result, conventional electric machines and the manufacturing thereof may be improved in order to achieve higher machine efficiency and output, and to prevent excessive heat that may cause damage and/or create mechanical problems.

### SUMMARY

It is therefore desirable to obviate the above-mentioned disadvantages by providing a structure and method for improving the heat transfer in a segmented stator.

According to an exemplary embodiment, a stator assembly of an electric machine includes a segmented lamination stack formed of an interconnected series of lamination segment stacks and a plurality of coil isolators each having a conductor wound thereon, each having a radially outward interlock at each circumferential end thereof, and each having a radially inward interlock at each circumferential end thereof, the coil isolators being serially connected by the interlocks to form a cavity closed along the axial length of the stator assembly, the coil isolators electrically insulating the lamination segments from the conductors.

According to another exemplary embodiment a stator assembly includes interlocking coil isolators connected to form a mold substantially closed down the axial length of the stator assembly.

According to a further exemplary embodiment, a method of integrating a stator assembly includes serially interlocking a plurality coil isolators to form a cavity substantially closed along its axial length, each coil isolator being wound with a coil of conductor wire, and filling the cavity with a thermally conductive material.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein

FIG. 1 is a schematic view of an electric machine;

FIG. 2 is a partial top plan view of a conventional segmented stator assembly;

FIG. 3 is a perspective view of a stator segment lamination stack;

FIG. 4 is a perspective view of an end cap being assembled onto a stator segment lamination stack;

FIG. 5 is a top plan view of a lamination that is stacked to form a stator core segment, according to an exemplary embodiment;

FIG. 6 is a perspective view of a two-piece isolator, according to an exemplary embodiment;

FIG. 7 is a perspective view of a stator segment according to an exemplary embodiment;

FIGS. 8A-8C show three respective interlocking structures;

FIG. 9A and FIG. 9B are partial perspective views of stator segments joined together, according to an exemplary embodiment;

FIG. 10 is a perspective view of a segmented stator prior to closure of axial ends thereof, according to an exemplary embodiment;

FIGS. 11A and 11B are perspective views of a segmented stator being enclosed at axial ends thereof, according to an exemplary embodiment;

FIG. 12 is a perspective view of a bus bar enclosure of a segmented stator assembly, according to an exemplary embodiment;

FIG. 13 is a top plan view illustrating perforations in the bottom tray of a bus bar track enclosure, according to an exemplary embodiment; and

FIG. 14 is a partial cross-sectional view of another exemplary embodiment for bus bars and an associated enclosure.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

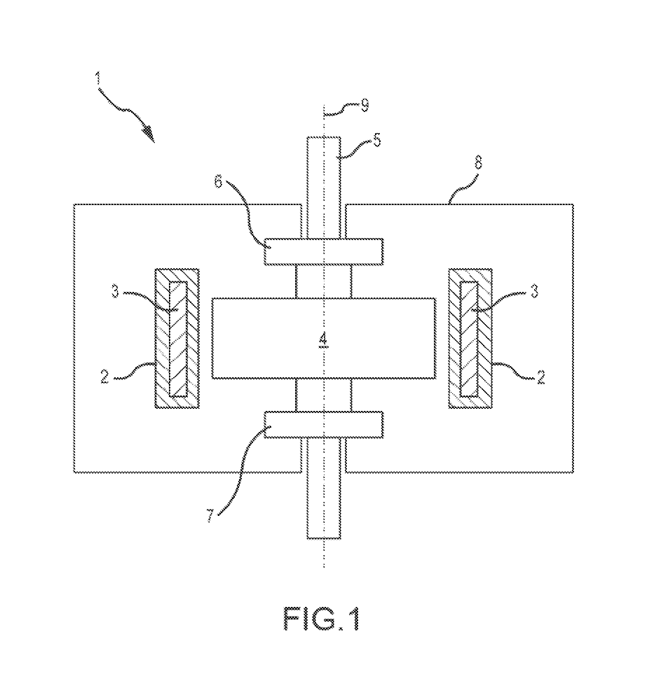

FIG. 1 is a schematic view of an exemplary electric machine 1 having a stator 2 that includes stator windings 3 such as one or more coils. An annular rotor body 4 may also contain windings and/or permanent magnets and/or conductor bars such as those formed by a die-casting process. Rotor body 4 is part of a rotor that includes an output shaft 5 supported by a front bearing assembly 6 and a rear bearing assembly 7. Bearing assemblies 6, 7 are secured to a housing 8. Typically, stator 2 and rotor body 4 are essentially cylindrical in shape and are concentric with a central longitudinal axis 9. Although rotor body 4 is shown radially inward of stator 2, rotor body 4 in various embodiments may alternatively be formed radially outward of stator 2. Electric machine 1 may be an induction motor/generator or other device. In an exemplary embodiment, electric machine 1 may be a traction motor for a hybrid or electric type vehicle. Housing 8 may have a plurality of longitudinally extending fins (not shown) formed to be spaced from one another on a housing external surface for dissipating heat produced in the stator windings 3.

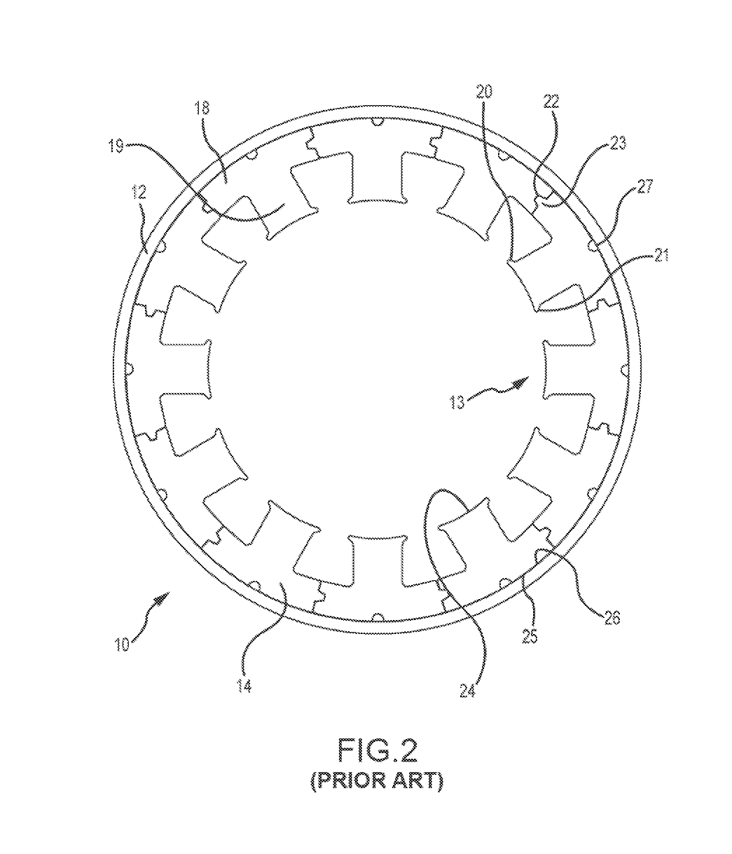

FIG. 2 is a partial top plan view of a conventional segmented stator assembly 10 that includes a housing 12 that encloses an outer circumference of a segmented stator 13. A rotor (not shown) is supported for rotation within stator 13. Each stator segment 14 may be formed as a solid core or as a stack of individual laminations, typically steel such as silicon steel coated with an electrical insulator. In the illustrated example, twelve stator segments 14 are serially mated to form an annular stator. Each stator segment 14 has a yoke portion 18 and a tooth shaped pole portion 19. The teeth 19 each have an arcuate inner edge surface 24 and circumferentially extending projections 20, 21. Yoke 18 has a circumferential tongue projection 23 extending axially on one circumferential end and has a circumferential groove 22 extending axially on the opposite circumferential end thereof. Stator segments 14 are serially mated by placing the tongue 23 of a segment 14 into the groove 22 of an adjacent segment 14. The arcuate radially outward surfaces 25 of stator segments 14 abut the annular inner surface 26 of housing 12, whereby housing 12 retains stator segments 14 in an annular shape. The radially inward surfaces 24 of each respective tongue portion 19 are thereby aligned in a circle facing the rotor. The tongue and groove connections between stator segments 14 allow easy assembly of a segmented stator.

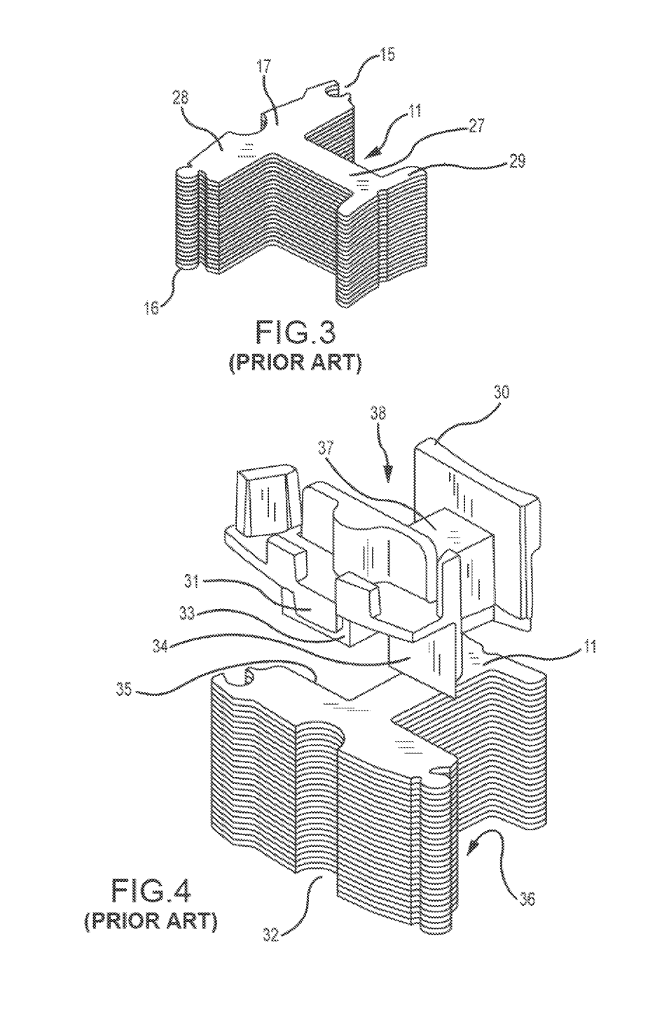

FIG. 3 is a perspective view of a conventional lamination stack 11 composed of identical individual laminations 17 formed of electrical steel or silicon steel and each having an electrically insulative coating. For example, lamination 17 may be punched from sheet steel having a thickness between 0.25 mm and 2.5 mm, or other. Laminations 17 each have a concave slot 15 and a corresponding convex tab projection 16. Lamination stack 11 is typically formed by aligning and fixing individual laminations 17 using a mold and an adhesive or other structure for bonding lamination stack 11 into an integrated stator segment core. Lamination stacks 11 may be serially connected by coupling concave slots 15 and convex tabs 16. Lamination stack 11 is roughly in the form of an “I” with a substantially flat center portion 27 connecting yoke portion 28 and tooth portion 29.

FIG. 4 is a perspective view of a conventional insulator 30 positioned for being mounted onto lamination stack 11. Insulator 30 has an outer axially-extending projection 31 having a same general shape as, and structured for snugly fitting into, a corresponding cavity 32 of lamination stack 11. Similarly, insulator 30 has a pair of inner axially-extending projections having respective contacting surfaces 33, 34 that are placed in close proximity to or that abut corresponding inner surfaces 35, 36 of lamination stack 11. A hollow center portion 37 of insulator 30 has an interior space for enclosing center portion 27 of lamination stack 27, where a flap (not shown) or separate cover piece is provided for insulating the bottom surface of center portion 27. When insulator 30 is fully installed, wire (not shown) is wound around center portion 37 to form a coil in winding space 38, and the wire ends are routed out of winding space 38 for connection to terminals (not shown) or to other conductors.

Various insulating structures have conventionally been used for electrically isolating the coil wire from lamination steel and other conductive surfaces to prevent electrical shorting, for preventing abrasion or other physical damage to coils, and for improving safety by minimizing exposure to dangerous voltages. However, conventional structures and methods are not optimized for removing heat from a segmented stator. In particular, much of the unused volume within conventional stator assemblies contains air, which is an extremely poor conductor of heat. In certain applications such as vehicular engines exposed to sufficient air flow, a use of air as a cooling medium may be sufficient. By comparison, trapping air in proximity to a heat source within an electric machine greatly reduces the machine's capacity for removing the associated heat.

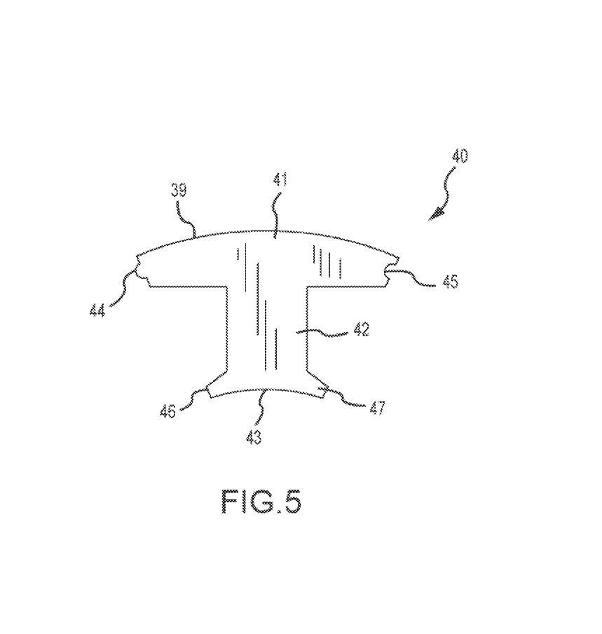

FIG. 5 is a top plan view of a lamination 40 that is stacked to form a stator core segment. Lamination 40 has a yoke portion 41, a center portion 42, and a tooth portion 43. Yoke 41 has a tongue 44 on one circumferential end and a groove 45 on the opposite circumferential end, whereby stator core segments may be serially joined together by insertion of a tongue 44 of a first stator core segment with a groove 45 of an adjacent stator core segment. Tooth 43 has extending portions 46, 47 at opposite circumferential ends thereof. When a series of stator core segments are joined together to form a complete stator, the arcuate outer surface 39 of laminations 40 are joined to form a circle that may be supported within a housing (not shown), by a band, or by other structure.

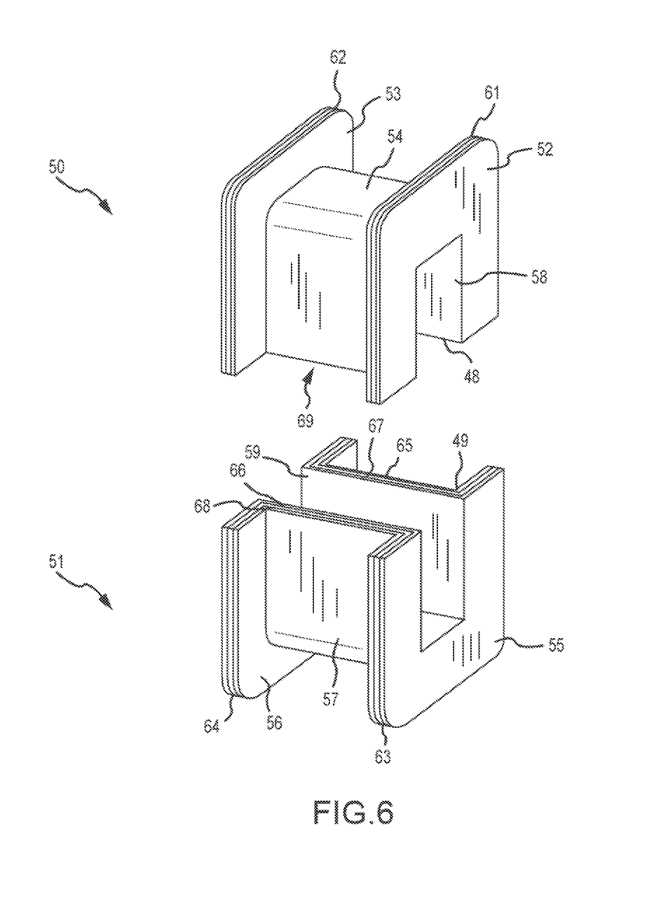

FIG. 6 is a perspective view of a two-piece isolator, according to an exemplary embodiment. The isolator, and associated covers and bus bar isolator tracks, may be formed of a resin having a high capacity for withstanding heat and stress and having high reliability. A top isolator piece 50 has a front flange 52, a rear flange 53, a wire winding portion 54, and an abutment surface 48. A bottom isolator piece 51 has a front flange 55, a rear flange 56, a wire winding portion 57, and an abutment surface 49. Respective center spaces 58, 59 and abutment surfaces 48, 49 of top and bottom isolation pieces 50, 51 are aligned with one another when top and bottom isolation pieces 50, 51 are joined together. Center spaces 58, 59 are thereby joined to create a volume having a width equal to or slightly greater than the width of center portion 42 of laminations 40 and having a height equal to or slightly greater than the height of the stacked laminations 40 that form the stator core segment. The depth of center spaces 58, 59 is equal to the respective distances between outward facing sides of flanges 52, 53 and between outward facing sides of flanges 55, 56, and is also substantially equal to the distance between yoke 41 and tooth 43 of lamination 40.

When a stator segment lamination stack has been assembled with laminations 40, a thermally conductive material is placed into center spaces 58, 59 of top and bottom isolation pieces 50, 51, and isolation pieces 50, 51 are then pressed together to enclose center portions 42 of laminations 40 inside center spaces 58, 59. Flanges 52, 53, 55, 56 are formed so that all outer edge surfaces thereof contain one of two corresponding mating members, as described further below. For example, flanges 52, 53, 55, 56 respectively have grooves 61-64 along the lengths of their edges. In addition, the top edge surfaces 67, 68 of bottom isolation piece 51 are formed with respective grooves 65, 66. The corresponding mating structure in this example is a tongue. For example, the edges of flanges 52, 53, 55, 56 of an adjacent structure, such as those for an adjacent top and bottom isolation pair 50, 51, may contain linearly extending tongue portions instead of grooves, whereby such adjacent structures may be coupled together. Top isolator piece 50 has an abutment surface 48 and a bottom isolator piece 51 has an abutment surface 49. Abutment surface 48 includes the bottom edges of flanges 52, 53 and the bottom lateral edges 69 of top wire winding portion 54, corresponding to surfaces 67, 68 of top isolation piece 50. Abutment surface 48 has longitudinal tongues that fit into grooves 65, 66, whereby the joining together of abutment surfaces 48, 49 is effected by a secure and tight seam. It is understood that any of grooves 61-66 and abutment surfaces 48, 49, in whole or in part, may be formed as either grooves or tongues so that the corresponding joinder of any such portion(s) to another structure may include engagement such as a sealing structure. The structural assembly of isolation pieces 50, 51 around the stator segment lamination stack and the placement of thermally conductive material therebetween may be performed so that all air is removed from the portion of spaces 58, 59 between the stator segment lamination stack and isolation pieces 50, 51.

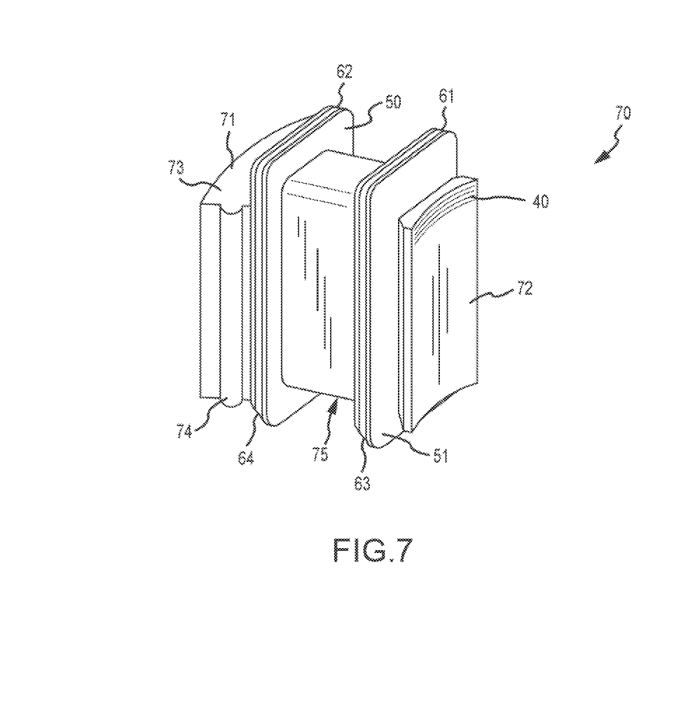

FIG. 7 is a perspective view of a stator segment 70 having a lamination stack 71 formed by stacking and aligning individual laminations 40. Typically, the construction of lamination stack 71 includes staking, adhering, fastening, and/or another method for maintaining structural integrity so that individual laminations 40 do not become loose or separate. The assembled top and bottom isolation pieces 50, 51 fit snugly between tooth portion 72 and yoke portion 73, and are sealed thereto by the previously placed thermally conductive material, for example a silicon, nylon, epoxy, resin, carbon fiber, or other suitable substance. When assembled, stator segment 70 forms a bobbin for winding a conductor coil in a wire winding space 75. The tongue 74 of stator yoke portion 73 fits into a corresponding groove of an adjacent stator segment.

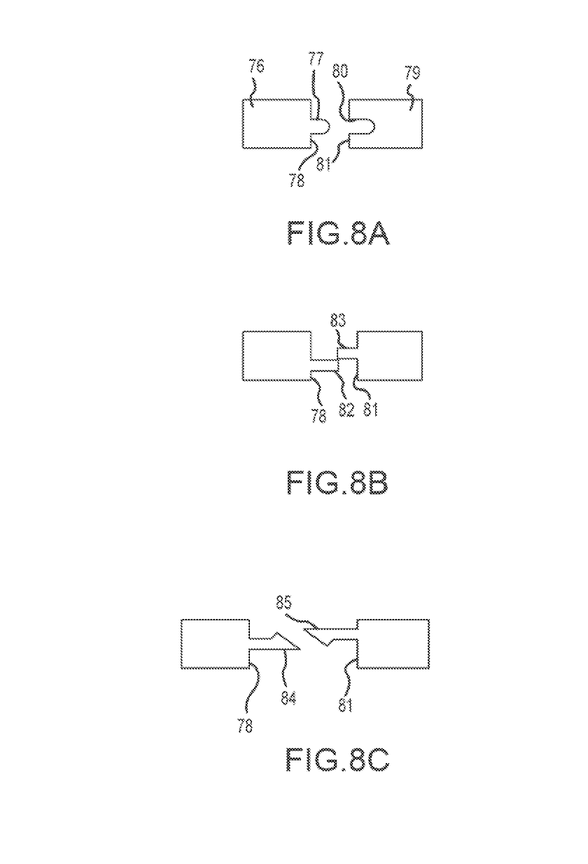

FIGS. 8A, 8B, 8C show different exemplary structure that may be substituted for tongues/grooves 61-66, 69 and other engaging/interlocking isolation structure of the exemplary embodiments. For example, FIG. 8A shows a first isolation section 76 having a tongue 77 and a mating surface 78, and a second isolation section 79 having a groove 80 and a mating surface 81. Tongue 77 snugly fits into groove 80 and mating surfaces 78, 81 abut one another when isolations sections 76, 79 are joined together. FIG. 8B shows another exemplary engaging/interlocking isolation structure where projections 82, 83 overlap one another to effect a sealing structure when mating surfaces 78, 81 are brought toward or into abutment. FIG. 8C shows a further exemplary engaging/interlocking isolation structure where hook 84 engages and interlocks with hook 85 as mating surfaces 78, 81 are brought toward or into abutment. These and/or many other structures may be used for joining together the various mating surfaces of isolation pieces 50, 51 for forming a stator segment 70 and/or for joining mating surfaces to an adjacent structure. For example, edge surfaces of isolators 50, 51 may be formed to overlap with opposed “L” faces, with detail and features for snap-fitting or interlocking, with tongue and groove structure containing a keyed portion, with a dove tail form that requires installing successive segments from the axial direction, and others.

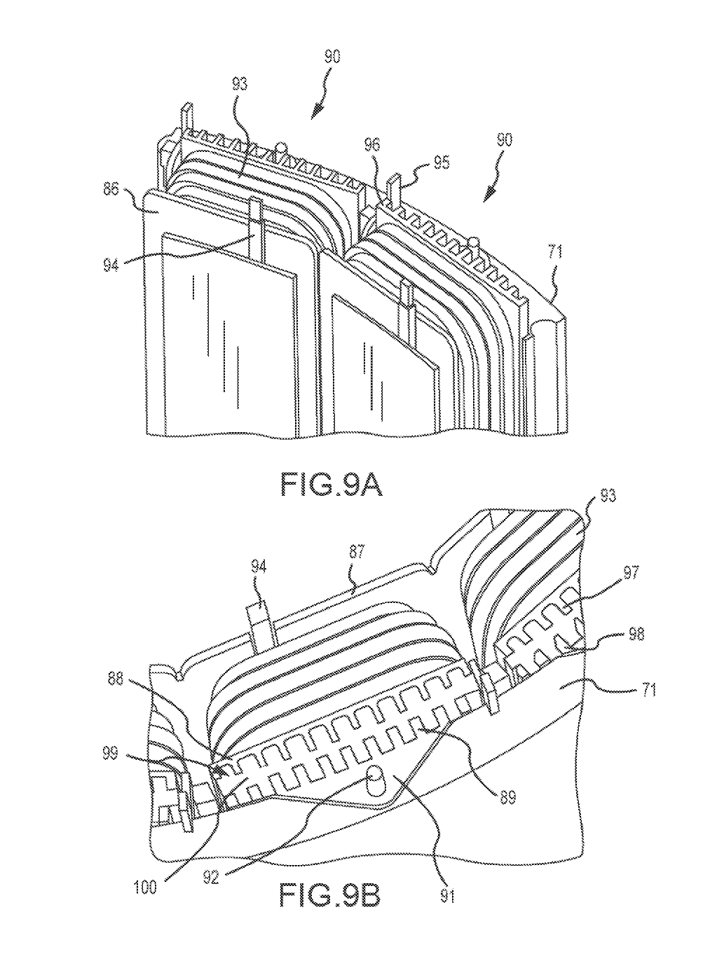

FIGS. 9A and 9B are partial perspective views of exemplary stator segments 90, each having a lamination stack 71 and a coil isolator 86. Coil isolator 86 has a radially inner flange 87 and two finned, opposed, radially outer flanges 88, 89. Outer flange 89 includes an axially outer portion 91 that extends radially outward along an axial end of lamination stack 71 and that includes an axially extending knob 92. Conductor wire 93 is wound around coil isolator 86 between flanges 87, 88 to form a coil having a first end 94 and a second end 95, each coil end 94, 95 extending axially from stator segment 90. In an exemplary embodiment, conductor wire 93 is rectangular wire with a cross section of approximately 1 mm by 3 mm. A wire support structure 96 is formed in flange 88 to guide, support, and seal the passage of conductor end 95 through an axially outer portion of flange 88. For example, wire support structure 96 may be a sealable slot, a molded guide, or another suitable structure. The opposed teeth/fins 97, 98 of respective flanges 88, 89 may optionally be formed to provide an additional thermal control. For example, the space 99 between finned flanges 88, 89 may be filled with a thermally conductive material 100. In such a case, the added surface area provided by fins 97, 98 is contiguous with thermal conductor 100, and different thermal conductors may be installed into space 99 to provide more or less heat transfer in specific portions such as hot spots. For example, a non-magnetic thermal conductor 100 may contain aluminum particles having a thermal conductivity of approximately 210 W/mK, and such may be selectively placed within space 99 to effect a maximum localized heat transfer for optimizing thermal control such as by channeling heat flow and creating radiation patterns. Alternatively, stator segments 90 may be formed without isolator fins 97, 98, and/or they may be formed with only a single radially outer flange on coil isolators.

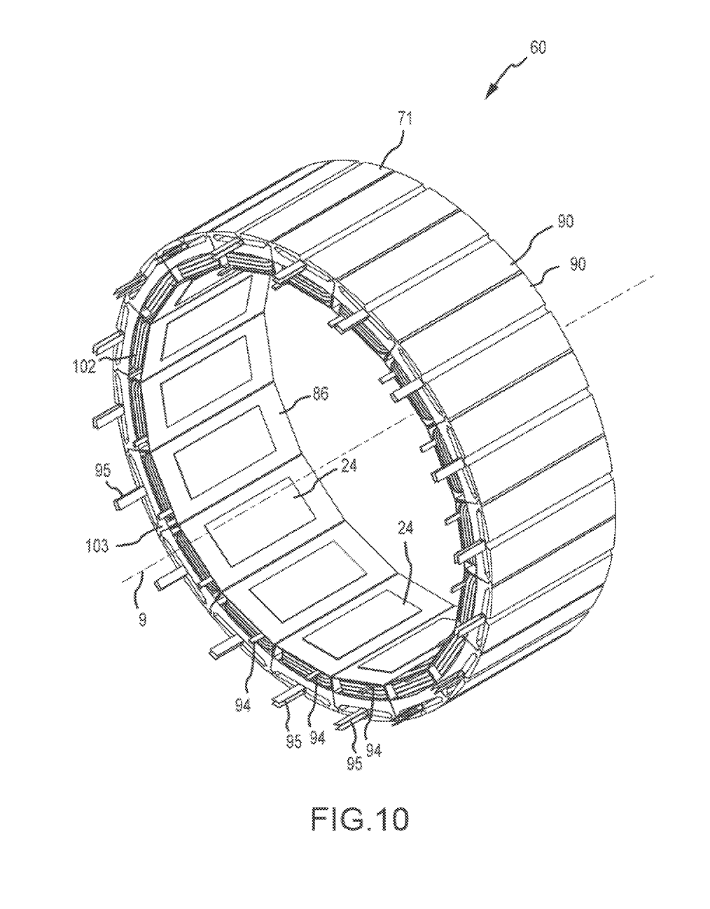

FIG. 10 is a perspective view of an exemplary segmented stator 60 having individual segments 90 joined together to form an annular shape about a center axis 9. Radially inward surfaces 24 of lamination stacks 71 face the center. As assembled, the joinder of coil isolators 86, by a tongue and groove or other structure, provides a chamber 103 containing coils 102. The radially inner and outer flanges of serially-joined coil isolators 86 are engaged by circumferential joining structure (e.g., FIGS. 8A-8C) with corresponding flanges of adjacent stator segments 90. As described above, coil isolators 86 are sealed to stator segment lamination stacks 71 with a thermally conductive material so that all adjoining surfaces, such as the interfaces of flanges 50, 51 with tooth portion 72 and yoke portion 73 of lamination stack 71 (e.g., FIG. 7) are sealed.

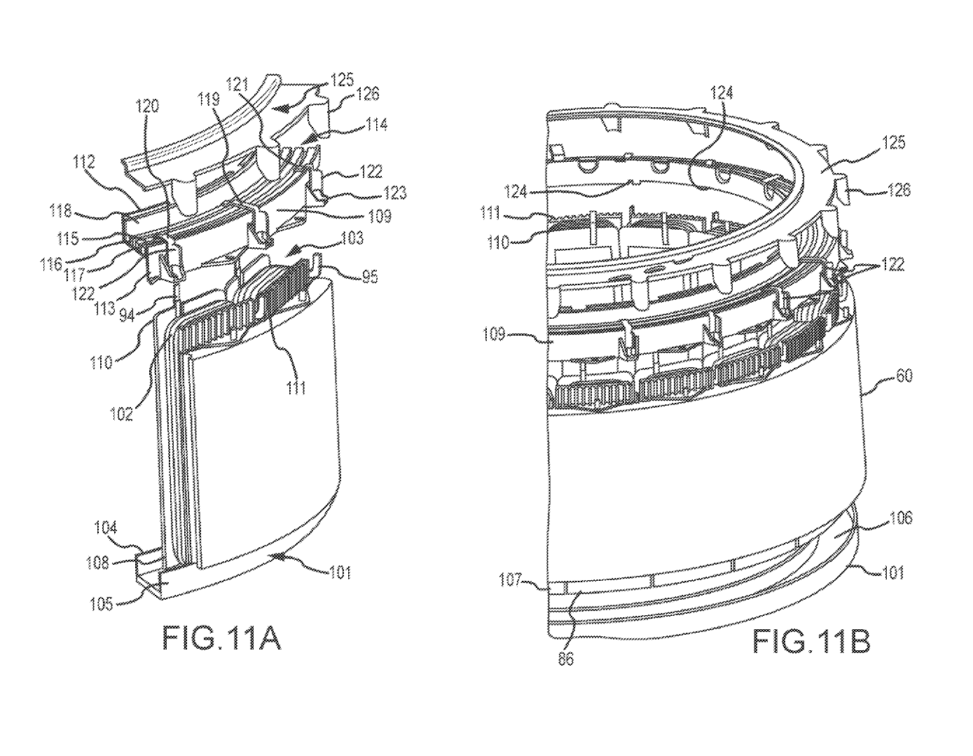

The structure of chamber 103 shown in FIG. 10 is open at axial ends thereof. FIG. 11A and FIG. 11B are partial perspective views showing exemplary structure for closing the axial ends of chamber 103. A U-shaped, annular end cover 101 has a center tray portion 106 and respective inner and outer ring walls 104, 105. End cover 101 may be assembled to segmented stator 60, for example, by filling tray 106 with thermally conductive compound such as potting compound, adhesive, epoxy, resin, or other appropriate material and then pressing end cover 101 into place so that axially extending, radially inward isolator portion 108 abuts wall 104, so that axially extending, radially outward isolator portion 107 abuts wall 105, and so that the thermally conductive compound seals the axial end of chamber 103 by sealing portions 107, 108 of coil isolator 86 to end cover 101. Optionally, connecting/mating structure such as locking/engaging tabs may be provided for securing end cover 101 to segmented stator 60.

At the other axial end of segmented stator 60, coil ends 94, 95 extend from respective coils 102. As shown, coil end 95 has two ninety degree bends. A bus bar isolation lower track 109 is a “mu-shaped,” annular tray structured to fit snugly onto the axial end of segmented stator 60 so that so that axially extending, radially inward isolator portion 110 abuts isolator wall 112, so that axially extending, radially outward isolator portion 111 abuts isolator wall 113, and so that coil ends 94, 95 are placed into abutment with corresponding electrical connectors. The interior tray space 114 contains three isolated bus bars 115-117 and a neutral conductor bar 118. Bus connectors 119-121 are respectively electrically connected to bus bars 115-117 such as by welding or by being integrally formed by casting or other construction. Bus connectors 119-121 each have axially oriented terminal portions 122 along the radially outward face of isolator wall 113. Coil ends 95 are respectively connected to such terminals 122, coil ends 95 being passed through isolation lower track 109 at molded partitions that are structured for preventing lateral enlargement of the corresponding conductor passageway. Similarly, coil ends 94 are passed through the bottom of lower track 109 via slots 124 formed radially outward of isolator wall 112. Interior isolation space 103 is filled with a thermally conductive material, either before or after placement of isolation lower track 109 and the subsequent electrical connections of coil ends 94, 95 and the filling of bus bar tray space 114 with thermally conductive material. After assembling lower track 109 and affixing it to segmented stator 60, a bus bar isolation top cover 125 is affixed onto lower track 109. Mating terminal covers 126 are molded into top cover 125 so that terminals 122 are covered and no hazardous voltage is exposed. In addition, terminal covers 126 may have a mating structure for meshing with corresponding structure of lower track 109 or with post 92 of an outer isolator flange and thereby holding top cover 125 in place.

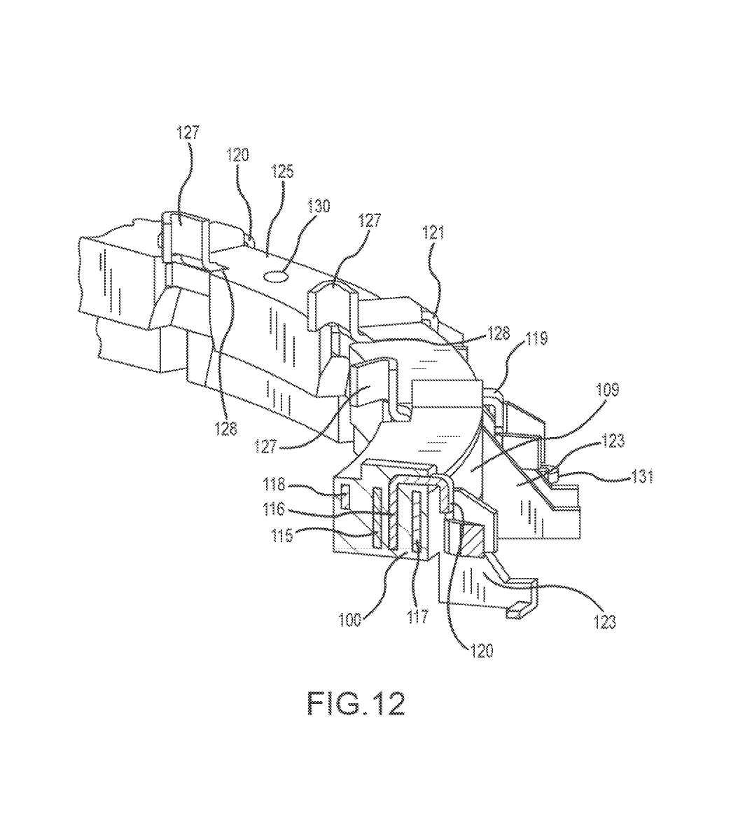

FIG. 12 is a partial perspective view exposing a cross section of an exemplary bus bar structure. Individual annular bus bars 115-117 are isolated from one another and may be oriented vertically as shown or lying flat in concentric channels (not shown) formed in lower track 109. An optional neutral bus bar 118 is also formed as a ring, and includes neutral connection terminals 127 that exit through holes 128 formed in top cover 125. Bus connectors 119-121 also exit via holes formed in top cover 125. Partitions 123 extend radially as integral portions of lower track 109. Other projecting portions of bus bar isolation lower track 109 may include supports 131 each having a bore for receiving a knob 92 and thereby securing lower track 109 to isolator 86. Thermally conductive material 100 fills lower track 109. Although various bus connections 119-121 are shown with portions outside a tray space 114, they may be enclosed by top cover 125, whereby only three conductors (one per phase) may exit through slots in top cover 125, thereby minimizing the number of apertures in the stator assembly.

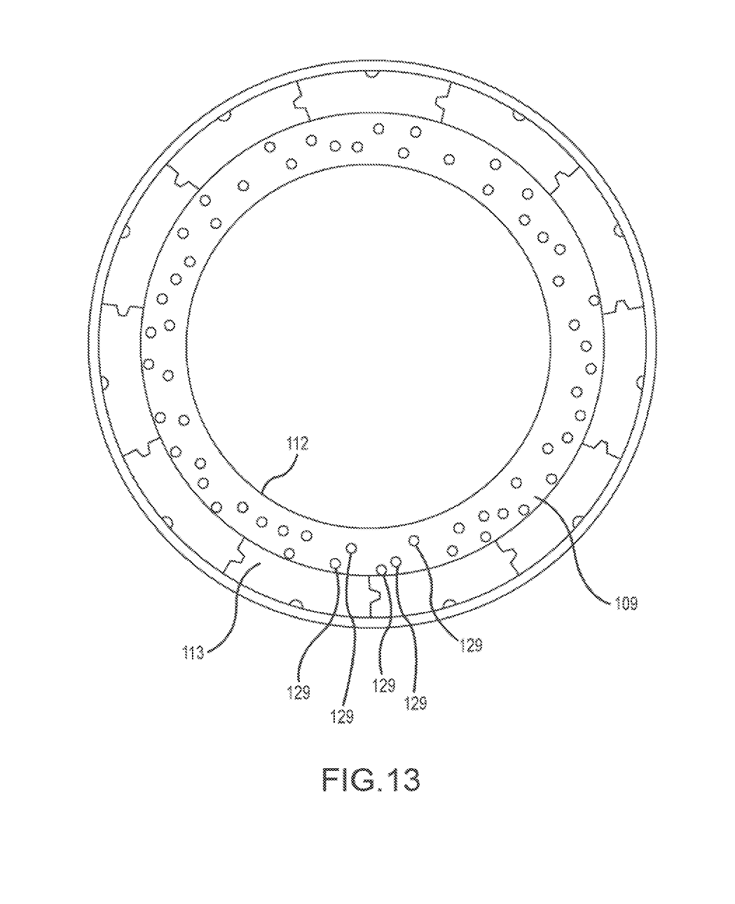

FIG. 13 is a top plan view of a lower track 109, omitting most details for illustrative purpose. Lower track 109 may optionally include holes 129 formed through the bottom floor thereof. Holes 129 may be selectively placed for flowing thermally conductive material 100, such as by injecting. In an exemplary embodiment, a low viscosity epoxy type material is used at least for a portion of thermally conductive material 100. When segmented stator 60 has been properly assembled, it effects a sealed compartment that includes spaces 103, 114, so that the low viscosity material may be poured into a top location, for example into one or more injection ports 130 (FIG. 12) formed in top cover 125. The low viscosity material 100 then flows down through holes 129 and fills voids between coil conductors, between adjacent coils, between all other structures, and eventually fills tray space 114. For example, a space with an approximate width of 4 mm may exist between adjacent coils 102. It may be desirable to place segmented stator 60 on a vibration table or similar mechanism during injection of thermally conductive material 100 in order to remove any trapped air bubbles. Similarly, other ports may be provided for placement of thermally conductive material 100. For example, sealable holes may be provided for multiple access to the sealed compartment for either injection or relief. Pressure/vacuum may be used when the sealed compartment has been fully sealed. For example, conductor passage holes 128 and any other aperture may be sealed by application and cure of a small amount of glue, silicon, or other sealing substance.

It is desirable to remove as much air as possible from segmented stator 60 and lower track 109. Therefore, any of the assemblies of parts may include the addition of sealing substances. For example, the coil isolators 50, 51, 86 may be affixed to lamination stack 71 by overmolding or by a process that replaces all intervening air with thermally conductive material 100. In another example, for securing coil wire 93 an adhesive may be used that, when heated, is activated to expand and force out air as it cures. The mating of any structure described herein may include the application of a thermally conductive material prior to or during assembly, and the associated use of air release holes that are subsequently sealed after removal of air. More than one type of thermally conductive material 100 may be installed for corresponding different portions of the stator assembly. For example, high viscosity material such as resin based potting compounds may be utilized in locations where it acts as a strain relief for conductor wires 93 and associated electrical connections thereof.

After being wound onto coil isolator 86, the finished coil may be vacuum impregnated in an intermediate manufacturing process. Typically, an electric varnish is used to remove air within each coil and to create an integral and mechanically stable coil structure. The segmented stator cores 60 is varnished at some point after the coils 102 have been placed on the stator segments. The varnish provides electrical insulation and also limits relative movement of the individual wires forming the coils. The varnish can be applied to individual stator segments after the coil has been wound thereon. Alternatively, the entire stator assembly can be varnished after the individual segments have been secured together into a complete stator assembly. Selected portions may be masked off to prevent being varnished.

Prior to placement of thermally conductive material into tray space 114, coil ends 94, 95 are welded to power supply wires (not shown), to terminals 122, or to other appropriate electrical connection. Resistance welding may be used for minimizing heating of lower track 109, top cover 125, and/or stator segment 60. Masks may be temporarily installed to prevent welding damage to adjacent structure.

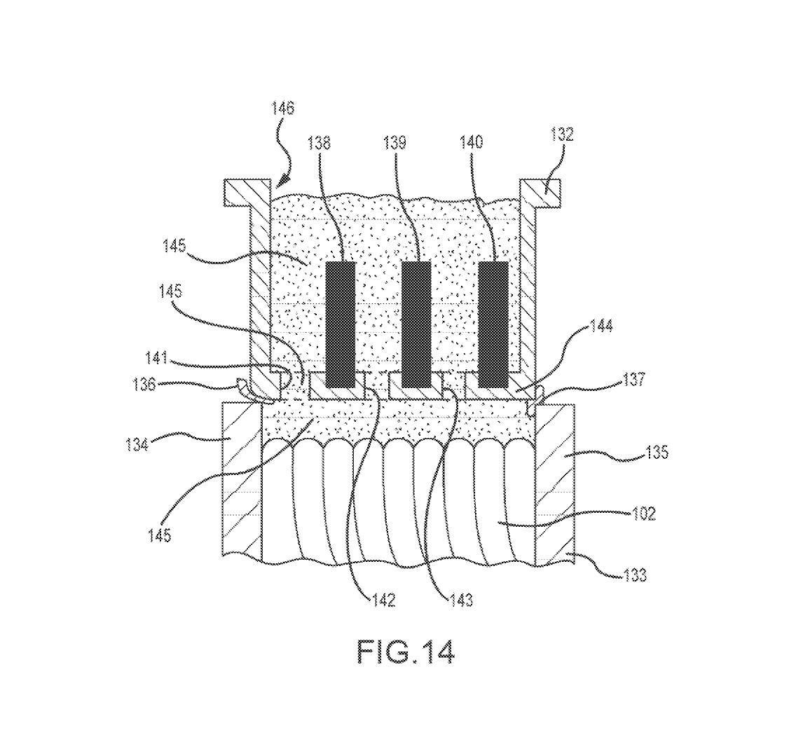

FIG. 14 is a partial cross-sectional view of another exemplary embodiment for bus bars and an associated enclosure. After a coil 102 has been wound onto an isolator 133 having flanges 134, 135, coil 102 is lacquered and coil ends 94, 95 (e.g., FIG. 9A) have been positioned, a bus bar isolation lower track 132 is secured to flanges 134, 135. Seals 136 such as gaskets, tongue and groove mating portions, or other appropriate structure sealingly couple lower track 132 to isolator 133. Bus bars 138, 139, 140 are molded into bus bar isolation lower track 132 prior to assembly. Lower track 132 has via holes 141-143 formed in portions of a bottom wall 144 between bus bars 138-140 and in any additional spaces a lateral distance from any bus bar. After assembly of lower track 132 to isolator 133, a thermally conductive material 145, such as a potting compound having appropriate thermal conductivity and viscosity, is poured into the top open end of lower track 132. Thermally conductive material 145 flows into lower track 132 and down through via holes 141-143 into the enclosed space containing coil 102. The assembly may be placed onto a vibration table and vibrated during installation of thermally conductive material 145 in order to purge any trapped air and to completely fill all spaces within the enclosure defined by the joinder of lower track 132 and isolator 133, including those spaces around coil 102, via holes 141-143, and spaces within lower track 132 including those spaces surrounding bus bars 138-140.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A stator assembly of an electric machine, comprising:
a segmented lamination stack formed of an interconnected series of lamination segment stacks; and
a plurality of coil isolators each having a conductor wound thereon, each having a radially outward interlock at each circumferential end thereof, and each having a radially inward interlock at each circumferential end thereof, the coil isolators being serially connected by the interlocks to form a cavity closed along the axial length of the stator assembly, the coil isolators electrically insulating the lamination segments from the conductors.

2. The stator assembly of claim 1, further comprising a first end cover engaged with the coil isolators and closing an axial end of the cavity.

3. The stator assembly of claim 2, wherein the first end cover comprises a motor cover.

4. The stator assembly of claim 2, wherein the first end cover is independent of a motor cover.

5. The stator assembly of claim 2, wherein the first end cover includes a bus bar electrically connecting selected ones of the conductors.

6. The stator assembly of claim 1, further comprising a bus bar electrically connecting selected ones of the conductors.

7. The stator assembly of claim 6, further comprising a substantially annular, perforated isolation ring for electrically isolating the conductors from the bus bar while fluidly connecting an axial end of the cavity and a space containing the bus bar.

8. The stator assembly of claim 7, further comprising a second end cover for closing an axial end of the cavity and including the space containing the bus bar therewithin.

9. The stator assembly of claim 7, further comprising a thermally conductive potting material substantially filling the cavity including the space containing the bus bar.

10. The stator assembly of claim 1, further comprising a thermally conductive potting material substantially filling the cavity.

11. A stator assembly comprising interlocking coil isolators connected to form a mold substantially closed down the axial length of the stator assembly.

12. The stator assembly of claim 11, further comprising first and second end covers for closing respective axial ends of the mold.

13. The stator assembly of claim 11, wherein radially extending conductor channels are formed at respective connections of adjacent ones of the coil isolators, the stator assembly further comprising a plurality of coils of conductor wire, respective ends of the coils passing through ones of the conductor channels.

14. The stator assembly of claim 11, further comprising a plurality of coils wound around respective ones of the coil isolators and a thermally conductive material substantially filling the mold.

15. A method of integrating a stator assembly, comprising:
serially interlocking a plurality coil isolators to form a cavity substantially closed along its axial length, each coil isolator being wound with a coil of conductor wire; and
filling the cavity with a thermally conductive material.

16. The method of claim 15, further comprising electrically connecting selected ends of the coils with a bus bar.

17. The method of claim 16, further comprising placing an isolating partition between the coils and the bus bar.

18. The method of claim 17, wherein the filling includes flowing the thermally conductive material through the isolating partition.

19. The method of claim 17, further comprising routing ends of the coils through a top cover.

20. The method of claim 19, wherein the filling includes injecting the material through holes in the isolating partition.

21. The method of claim 15, wherein the interlocking of coil isolators forms a notch at an axial end of the cavity at each interlock, the method further comprising passing one end of each coil through a corresponding one of the notches.

22. A method of integrating a stator assembly, comprising:
sealingly connecting a bus assembly to a coil isolator, the bus assembly including a plurality of integrally molded bus bars and a bottom portion, the bottom portion having via holes; and
fluidly installing a thermally conductive material into the bus assembly so that the thermally conductive material flows through the via holes and into space enclosed by the coil isolator.
